(19) United States
(12) Patent Application Publication
(10) Pub. No.: US 2018/0343397 A1
(43) Pub. Date: Nov. 29, 2018

(54) SYSTEMS AND METHODS FOR POSITION TRACKING

(71) Applicant: Zoptic, LLC, Littleton, CO (US)

(72) Inventors: Krithik Chandrashekar, Boulder, CO (US); William Check, Boulder, CO (US); Austin Glaser, Golden, CO (US); Daniel J. Bodenstein, Boulder, CO (US)

(21) Appl. No.: 15/989,955

(22) Filed: May 25, 2018

Related U.S. Application Data
(60) Provisional application No. 62/511,522, filed on May 26, 2017.

(51) Int. Cl. H04N 5/232; G06F 17/30; G01S 19/51; G01S 11/06; G01S 19/46

(52) U.S. Cl. CPC H04N 5/23296; G06F 17/30241; G01S 19/46; G01S 11/06; G01S 19/51

(57) ABSTRACT

Methods and systems are provided having a tag associated with a moving object are disclosed. An antenna of the tag transmits signals. A Global Positioning System (GPS) obtains GPS data for the tag. An anchor comprises an antenna that receives signals transmitted by the tag at the first frequency. A computer system receives both GPS data and information from the anchor indicative of a distance between the tag and the anchor and determines whether to track a position of the tag. A camera system includes a communication system that receives information about the position of the tag from the computer system. The camera system includes a camera control system that controls a position of a camera based on received information about the position of the tag from the computer system.

### RELATED APPLICATION

This application claims the benefit of U.S. Provisional Application No. 62/511,522 entitled “SYSTEMS AND METHODS FOR POSITION TRACKING” and filed May 26, 2017 which is incorporated herein by reference.

### FIELD

The present disclosure is generally directed to the use of a wearable position tracker, in particular, toward the use of a wearable position tracking comprising communication technology.

### BRIEF DESCRIPTION OF THE DRAWINGS

The present disclosure, in accordance with one or more embodiments, is described in detail with reference to the following figures. The drawings are provided for purposes of illustration only and merely depict typical or example embodiments of the technology. These drawings are provided to facilitate the reader's understanding of the technology and shall not be considered limiting of the breadth, scope, or applicability of the technology.

FIG. 1 is a block diagram showing an example environment for tracking one or more tags in relation to global positioning system (“GPS”) and/or radio frequency (“RF”) anchors using ultra-wideband (“UWB”) and for controlling a camera in accordance with some embodiments of the present disclosure;

FIG. 2 is a block diagram showing an example of a system for tracking players on a playing field and for controlling a camera capturing images of the players in accordance with some embodiments of the present disclosure;

FIG. 3A is a block diagram showing an example of a system for tracking RF tags using triangulation in accordance with some embodiments of the present disclosure;

FIG. 3B is a table showing an example set of data in accordance with some embodiments of the present disclosure;

FIG. 3C shows two formulas used in calculating positions of tags in accordance with some embodiments of the present disclosure;

FIG. 4A is a table showing an example set of signal strength data in accordance with some embodiments of the present disclosure;

FIG. 4B is a table showing an example set of signal strength and weighting data in accordance with some embodiments of the present disclosure;

FIG. 4C is a table showing an example set of position data in accordance with some embodiments of the present disclosure;

FIG. 4D is a table showing an example set of subject interest level data in accordance with some embodiments of the present disclosure;

FIG. 5 is a flowchart showing an example method for adjusting triangulation position data in accordance with some embodiments of the present disclosure;

FIG. 6 is a flowchart showing an example method for determining and applying weightings to data in accordance with some embodiments of the present disclosure;

FIG. 7 is a flowchart showing an example method for determining a subject of interest and moving a camera in accordance with some embodiments of the present disclosure; and

FIG. 8 is a flowchart showing an example method for determining and updating a location of a tag in accordance with some embodiments of the present disclosure.

### DETAILED DESCRIPTION

Embodiments of the present disclosure will be described in connection with a computer system in communication with one or more RF anchors and/or one or more wearable RF tags. While embodiments described herein may refer to a “computer system”, it should be appreciated that the capabilities described herein may in certain embodiments be performed by a server, personal computer, tablet device, smartphone, or other computing device.

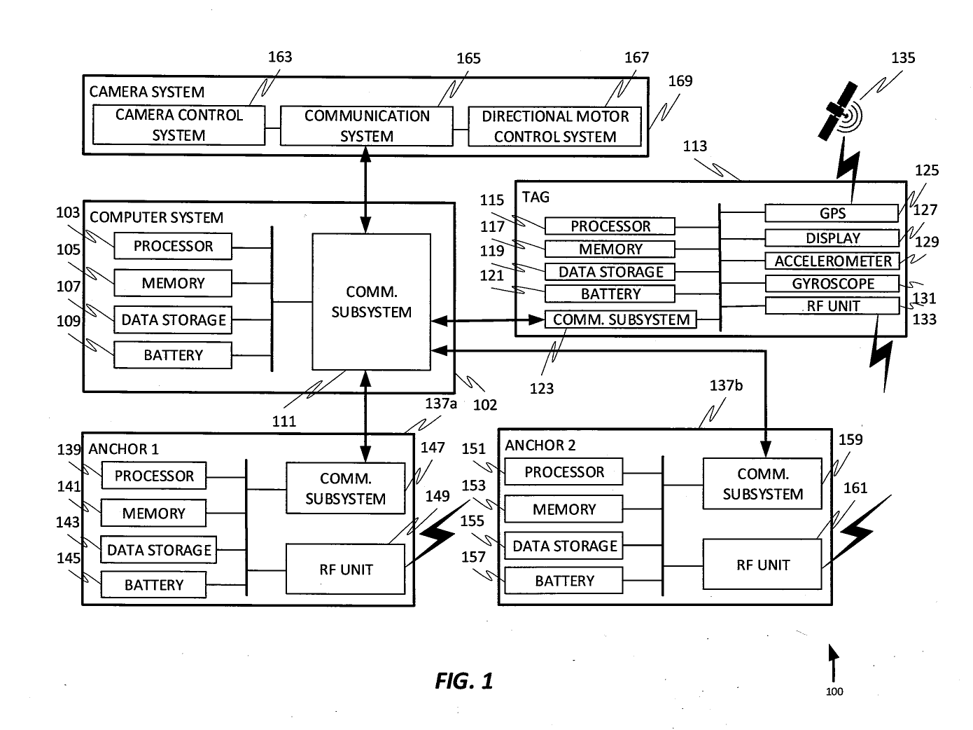

As illustrated in FIG. 1, an environment 100 may comprise a computer system 102 operable to communicate with one or more anchors 137a and 137b, one or more tags 113, and one or more camera systems 169.

A computer system 102 may in certain embodiments comprise a processor 103, a memory 105, a data storage system 107, a battery 109, and a communication subsystem 111. The communication subsystem 111 may operate to communicate with the one or more anchors 137a and 137b, one or more tags 113, and one or more camera systems 169. The communication subsystem 111 may, and while not specifically illustrated, include one or more communications links (that can be wired or wireless) and/or communications busses, including one or more of CANbus, OBD-II, ARCINC 429, Byteflight, CAN (Controller Area Network), D2B (Domestic Digital Bus), FlexRay, DC-BUS, IDB-1394, IEBus, I2C, ISO 9141-1/-2, J-Bus, J1708, J1587, J1850, J1939, ISO 11783, Keyword Protocol 2000, LIN (Local Interconnect Network), MOST (Media Oriented Systems Transport), and the like or in general any communications protocol and/or standard(s).

The various protocols and communications can be communicated one or more of wirelessly and/or over transmission media such as single wire, twisted pair, fiber optic, IEEE 1394, MIL-STD-1553, MIL-STD-1773, power-line communication, or the like. (All of the above standards and protocols are incorporated herein by reference in their entirety). Communication subsystem 111 may communicate via one or more of Wi-Fi, Bluetooth™, ethernet, cellular connection or other communication system as known in the art.

The environment 100 may comprise one or more wearable tags 113. A tag 113 may be in the form of a wristband, smartwatch, ankle band, a pouch sewed onto a garment, an element mounted onto a belt, etc. A tag 113 may comprise a processor 115, a memory 117, data storage system 119, a battery 121, a communication subsystem 123, a GPS system 125, a display 127, an accelerometer 129, a gyroscope 131, and/or an RF unit 133. The RF unit 133 may comprise an antenna and be capable of being detected by one or more of the anchors 137a and 137b. The GPS system 125 may operate to detect a position of the associated tag 113 via connection to GPS satellites 135. Via the communication subsystem 123, each tag may be capable of communicating with other tags, anchors 137a, 137b, the computer system 102, and other elements.

In some embodiments, a tag 113 may include a number of sensors, devices, and/or systems that are capable of assisting in position and/or location tracking operations. Examples of the various sensors and systems may include, but are in no way limited to, one or more of cameras (e.g., independent, stereo, combined image, etc.), infrared (“IR”) sensors, RF sensors, ultrasonic sensors (e.g., transducers, transceivers, etc.), RADAR sensors (e.g., object-detection sensors and/or systems), LIDAR systems, odometry sensors and/or devices (e.g., encoders, etc.), orientation sensors (e.g., accelerometers, gyroscopes, magnetometer, etc.), navigation sensors and systems (e.g., GPS, etc.), and other ranging, imaging, and/or object-detecting sensors. The sensors may also include sensors for detecting light, temperature, acceleration, etc.

In some embodiments, the environment 100 may comprise two anchors 137a and 137b. Each anchor may comprise one or more of a processor 139, 151, memory 141, 153, data storage 143, 155, battery 145, 157, communication system 147, 159, and/or an RF unit 149, 161. A communication system 147, 159, of an anchor 137a, 137b may be capable of communicating with a communication subsystem 111 of a computer system 102 via a wired or wireless connection. An RF Unit 149, 161 may be capable of detecting a distance between the associated anchor 137a, 137b and an RF unit 133 of one or more tags 113.

In some embodiments, anchors may be stationary objects. For example, anchors may be placed at edges of a field containing tags. The position of each anchor may be a constant stored in memory of the computer system. The position of each anchor may be set by a user of the computer system or may be determined in other ways. In some embodiments, a first anchor may be physically attached to and at or near the same position as the computer system while a second anchor may be some distance away from the computer system.

In some embodiments, the environment 100 may comprise more than two anchors 137a and 137b. For example, in some embodiments, the system may be implemented using more than two anchors. For example, additional anchors may be added. Adding anchors in excess of two may enable an increased number of triangulation points to be used by the computer system in determining and/or estimating the position of one or more tags throughout the environment. Through the use of a plurality of anchors, a scalable architecture may be achieved. For example, an environment may comprise three or more anchors. The computer system may be capable of using data received from each of the anchors in the environment in order to estimate and/or determine a position of one or more tags throughout the environment. When more than two anchors transmit trustworthy data to the computer system, the computer system may use such data to accurately determine and/or estimate positions of one or more tags. By using more than two anchors, in the event that one or more anchors goes offline or transmits untrustworthy data the computer system may be capable of using data from online and/or trustworthy anchors to accurately determine and/or estimate positions of one or more tags.

In some embodiments, the system may be capable of performing in the absence of multiple anchors. For example, a system may be set up with multiple anchors and in the event that one or more anchors ceases to properly function or otherwise goes offline, one or more tags may be used by the computer system to substitute for the offline anchors.

In some embodiments, the system may be set up without any anchors. For example, tags may be used to create a mesh-network in which the location of each tag may be estimated or determined by the computer system based on information received from each tag.

The environment 100 may comprise a camera system 169. A camera system 169 may comprise a communication system 165 operable to communicate with a communication subsystem 111 of a computer system 102. A camera system 169 may comprise a communication system 165 may also comprise a camera control system 165 and a directional motor control system 167. A camera control system 165 may be operable to control functions of a still or video camera. For example, the camera control system 165 may be capable of powering on a camera, beginning and ending a recording, automatically adjusting a focus, framerate, aperture, shutter speed, zoom, etc. A directional motor control system 167 may be capable of controlling a motor operable to automatically adjust a direction, pan, tilt, and/or position of a camera on a mount, tripod or dolly.

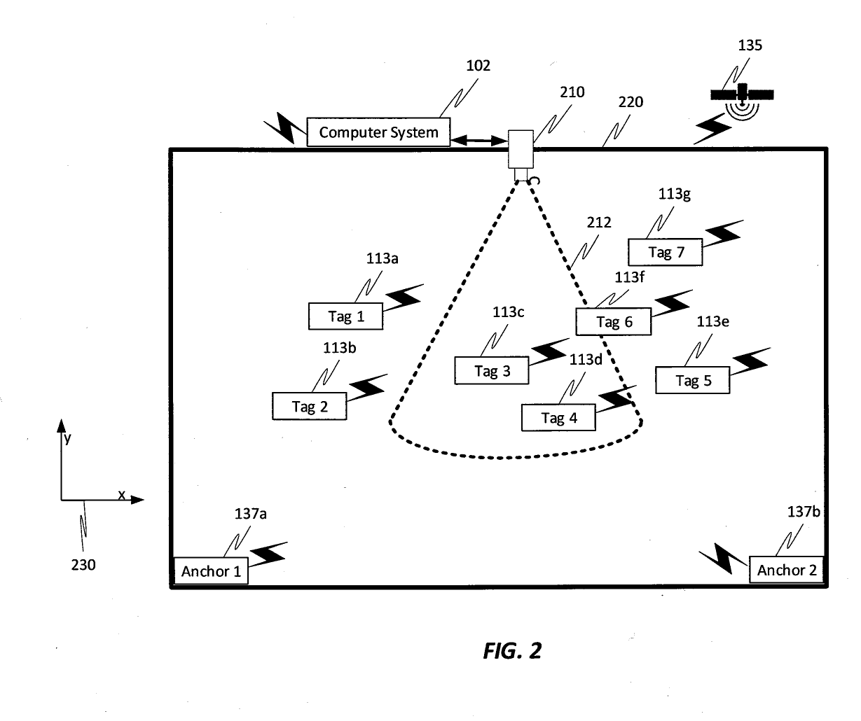

In certain embodiments, the components of environment 100 may be used to track the position of a number of tags 113a-g on a playing field 220 and to control a camera 210 to record video of wearers of the tags 113a-g as illustrated in FIG. 2. For example, in some embodiments, a playing field 220 (e.g. a soccer field) may comprise a number of players each wearing a tag 113a-g. On or near the field 220 a camera 210 may be set up and connected to a computer system 102. The camera 210 may comprise the elements shown in FIG. 1 related to the camera system 169. For example, in some embodiments, the camera 210 may be on a computer-controlled tripod wherein the computer system 102 may be capable of adjusting the direction, zoom, tilt, recording mode, etc. of the camera 210. In some embodiments the camera 210 may be on a dolly track in which the camera 210 may be moved alongside the field 220 as controlled by the computer system 102. The camera 210 may have a field of view 212 in which certain portions of the field 220 may be in view and/or in focus while certain other portions of the field 220 may be out of view and/or out of focus.

While FIG. 2 illustrates an environment comprising multiple anchors 137a, 137b, it should be clear that such anchors need not be stationary objects. The anchors 137a, 137b, may simply be in the form of tags worn by players. In some embodiments, the location of any given tag 113a may be estimated by the computer system 102 based on data received from other tags 113b, 113c. The position may be determined based on an analysis of the strength of RF signals between the tags 113a-113g.

In some embodiments, the computer system may receive data from sources such as external services and other devices. For example, devices such as heart rate monitors, smart watches, etc. may transmit data to the computer system via one or more communication means such as via Bluetooth™, ANT+, etc. Data transmitted from such devices may include, but is not limited to, heart rate, cadence, body temp, blood flow, head impact, GPS location, etc. The data sent from the devices may be raw data or may be processed or interpreted in some way by a processor of the device prior to being sent to the computer system. Data received from an external service or device may be associated with one or more tags. For example, a player on a field may be wearing both a tag and a device such as a heartrate monitor. Data from the heartrate monitor may be received by the computer system and may be interpreted by the computer system as relating to the data associated with the tag worn by the player.

In some embodiments, the computer system may receive data from a plurality of sources. Such data streams may be synchronous and/or asynchronous data streams. For example, data received by the computer system may be sent to and received by the computer system in real-time. Such real-time data may be analyzed by the computer system as it is received. When asynchronous or non-real-time data is received by the computer system, the system may buffer received data in order to analyze all data received relating to a particular time together in order to properly determine and/or estimate a position of a tag.

As shown in FIG. 2, in some embodiments two or more anchors 137a, 137b, as described in FIG. 1, may be placed on or near the field. Each anchor 137a, 137b may operate to estimate a distance between the anchor 137a, 137b and a tag 113a-g. The anchors may communicate with the computer system 102 such that the computer system 102 may receive the distance estimates and, using a value for a distance between the anchors 137a and 137b, estimate a position of each tag 113a-g on the field 220. The distance between the anchors 137a and 137b may be an estimated value entered by a user of the computer system 102, or may be estimated by one or both of the anchors using RF. For example, a user may physically measure the distance, estimate the distance, or place the anchors on known distances such as on end-zone lines of a football field. The positions of the tags 113a-g may be coordinates on an X/Y axis 230 as illustrated in FIG. 2. For example, a bottom left corner of a playing field may be at coordinate (0,0). In some embodiments, a first anchor 137a may be at coordinate (0,0) while a second anchor 137b may be at coordinate (AA′,0), wherein AA′ represents the distance between the two anchors 137a, 137b.

In some embodiments, the computer system 102 may further estimate positions of the tags 113a-g by receiving GPS coordinates from the tags 113a-g as determined by GPS systems on the tags 113a-g using GPS satellite 135 information. The tags 113a-g may also estimate movement and/or position using onboard accelerometers and/or gyroscope sensors. The tags 113a-g may transmit information to the computer system 102 using any means of communication, such as Bluetooth, WIFI, cellular, etc.

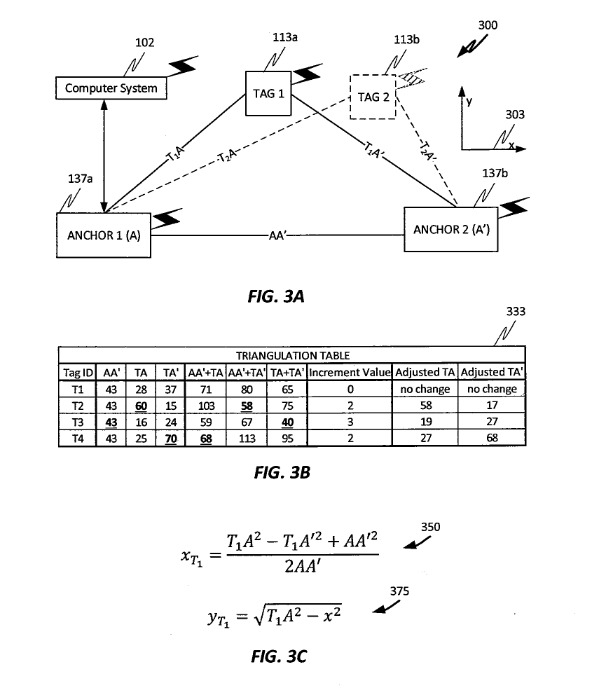

As shown in the environment 300 illustrated in FIG. 3A, a computer system 102 may track positions of tags 113a-b using anchors 137a-b. Using RF Units, each anchor may be able to detect and estimate a distance between the anchor 137a-b and the tag 113a-b. The distance estimate may be transmitted from each anchor 137a-b to a computer system 102. Using the received distance estimates and a value for the distance between the anchors 137a-b, the computer system 102 may determine a position of each tag 113a-b on an x/y coordinate system 303.

In the event that one or more anchors 137a, 137b are offline or otherwise absent, the computer system 102 may be capable of determining or estimating locations of tags based on data such as RF signal strength of each tag as received by other tags. The tags may effectively create a mesh-network which may be analyzed by the computer system 102 to determine relative locations of each of the tags even without stationary anchors.

The computer system 102 may store the received distances in memory in the form of a table 333 as shown in FIG. 3B. Due to possible imprecise estimates, a correction equation may be used to adjust the estimates. For example, the system may only have a solution to the coordinates of a tag when the distances between the tag and the two anchors and the distance between the anchors forms a triangle. The three distances may form a triangle only if the sum of each pair of distances is greater than the third. Due to certain measurement error, in certain cases the estimated distances may lead to non-physical conditions. To account for such a situation, and to allow performance of the system when measurement error precludes an immediate solution, the computer system may employ a procedure to increment or decrease an estimated distance value by a certain amount.

Because the distance between the anchors (AA′) may be unchanging and may be a known value, the estimated distances between the tag and each anchor (TA and TA′) may be increased or decreased based on a determination that one distance may be over or under estimated. The computer system may compare the three distance values (AA′, TA, and TA′) and determine an error situation has occurred. For example, if it is detected that a particular side estimate may be too long, that side may be decreased and if a particular side estimate may too short that side may be increased. As can be appreciated in FIG. 3B, in the entry for Tag ID T1, no combination of two distance elements is smaller than any one side. In the entry for Tag ID T2, the combination of AA′ and TA′ is less than the value for TA. Such a scenario may indicate an error situation. In an error situation, an increment value may be applied to adjust the TA and TA′ values. In the case of T2, the side TA may be decreased and the side of TA′ may be increased to compensate for the error. In some embodiments, the increment value may be calculated as the long value minus the sum of the two short values.

For simplicity, embodiments are described herein in terms of a system using two anchors; however, such descriptions should not be considered as limiting embodiments to only two anchors. In some embodiments, three or more anchors may be used. For example, the computer system may use data from three different anchors in order to determine a position of a tag. In some embodiments, three or more anchors may be placed around a field and the computer system may determine a weighting of each measurement received from each anchor in order to generate a best estimate for a position of a tag. For example, the computer system may determine two anchors provide relatively more accurate or trustworthy data compared to other anchors. The computer system may then rely more heavily on the data received from the more reliable anchors.

As illustrated in FIG. 3C, formulas using the three distance estimates (TA, TA′ and AA′) may be used to calculate coordinates for each tag. Because triangulation position tracking using anchors may not be a perfect system, the tags may be equipped with other position tracking systems, including, but not limited to, GPS sensors, accelerometers, and/or gyroscope sensors. By combining such sensor data with the data received from anchors (Ultra-Wideband “UWB”), the resulting position estimate may have less uncertainty than would be possible when such sources are used individually. While GPS may be best suited for large outdoor environments, where the subject moves beyond the range of anchors or UWB radio, and UWB may be best suited for close indoor environments, where GPS is accessible, GPS and UWB may be combined in certain situations. Also, data received from accelerometers and/or gyroscope sensors in the tags may additionally supplement, or replace, GPS and/or UWB data to optimize the estimated positions.

By taking into account the diversity of the sensors and the environments that they best function in, the location data may therefore be a weighted result. Estimation algorithms/filters may be applied to the data to smooth the resultant data. In some embodiments, a Kalman Filter may be used to produce position estimates.

Each data source (e.g. UWB, GPS, etc.) may be evaluated for degradation. For example, with an UWB ranging system, line-of-sight obstructions and (to a lesser extent) RF interference can degrade data quality. One feature of some embodiments may be that the system may be able to detect the degree of such degradation and handle poor fixes differently from good ones (for instance, to apply a different filtering scheme or give more weight to other data sources).

In some embodiments, one or more custom algorithms and/or processes may be utilized by the computer system to determine a weight each one of a plurality of data streams should be assigned in the analysis. For example, a user may set one or more preferred characteristics for the data. The computer system may use such preferred characteristics in the determination of the weight each data stream should be assigned for the analysis. Assigned weightings may depend on the type of activity or sport being performed, may depend on whether the system is being used indoors or outdoors, or may depend on any other relevant factor. In some embodiments, the computer system may utilize one or more of adaptive and/or predictive algorithms. For example, weightings of each data stream may change during the use of the system depending on changes in factors occurring throughout the use.

Such a metric may be difficult to estimate from a single fix. However, a sequence of such fixes may exhibit increased “roughness” (high and random variation between subsequent samples) when localization quality is degraded. In some embodiments, the system may measure roughness by calculating the standard deviation of differences between adjacent samples over a period of time. This method has the advantage of producing low values for constant-velocity motion.

Dead reckoning is a process that uses instantaneous acceleration readings to determine relative motion from a starting position. Accelerometer and gyroscope data may be integrated to arrive at position and heading respectively. The error sources from the sensors may be compounded with time to produce a drift when integrated. To get around this, the GPS and UWB data may provide absolute location information that may be used to essentially correct the estimation. Conversely, the high accuracy of dead reckoning over short (under ten second) time scales may be used to reject outliers from RF-based localization techniques.

In some embodiments, the base system may need two anchors to track a tag. Localization with UWB may be improved with multiple anchors, but the placement of more than two fixed anchors may lack user-friendliness. However, in an environment with multiple tags, the tags can essentially operate as floating anchors. This cloud of tags can perform mutual ranging, and the tags' locations relative to one another can be estimated. The full system can then be located absolutely based on the best anchor-tag location fixes. This can be especially valuable in cases where there is interference between a fixed anchor and a tag, but there is clear line-of-sight between two tags. For this reason, a tag may be capable of performing as a movable, or unfixed anchor. The tag performing as an anchor may be worn by a user and perform the mutual ranging required to position other tags. The position of a tag performing as an anchor may similarly be tracked by other tags performing as anchors.

In a multi-tag environment, there may be situations where the system may not be able to capture all subjects in a single field of view. In these situations, the system will intelligently determine where to point the camera using one of several methods. These methods may be user selectable, or an appropriate one might be selected based on the configured sport. Any strategy will employ some degree of hysteresis or “stickiness,” to avoid the system changing subjects too rapidly. One strategy may seek to maximize the number of subjects in the camera's view at any given time or may be to focus on one particular subject.

In some embodiments, a strategy may focus the camera on the subject which is the most “interesting” by some metric. This metric could include: Subject Velocity, which will tend to favor subjects moving quickly across the field. (possibly appropriate for soccer, basketball, and football), Subject Acceleration, tending to favor subjects who change their direction or speed of motion. (possibly appropriate for soccer and basketball), and/or Subject Location, tending to favor subjects furthest ahead in the average direction of motion (possibly appropriate for track sports).

In some embodiments, a strategy may be employed to favor subjects whose location is known with the most accuracy. This will tend to favor subjects with line-of-sight to both anchors, and therefore better visibility to the camera.

In some embodiments, the computer system may employ particular known rules for certain sports to improve localization fixes based on known movement patterns. Such a system may include a range of different heuristics, including, for track sports, competitors may be unlikely to quickly reverse or change direction and instead may maintain a relatively constant velocity. In such a situation, sharp velocity and direction changes may be rejected as possible noise. In some sports there may be a range of normal speeds at which competitors move. Position changes exceeding such speeds may be rejected as possible noise. Player movement patterns may in some situations be different at different locations in the play field. For example, mid-court vs. near the baskets for basketball, and the system may use a different kinematics model based on player location.

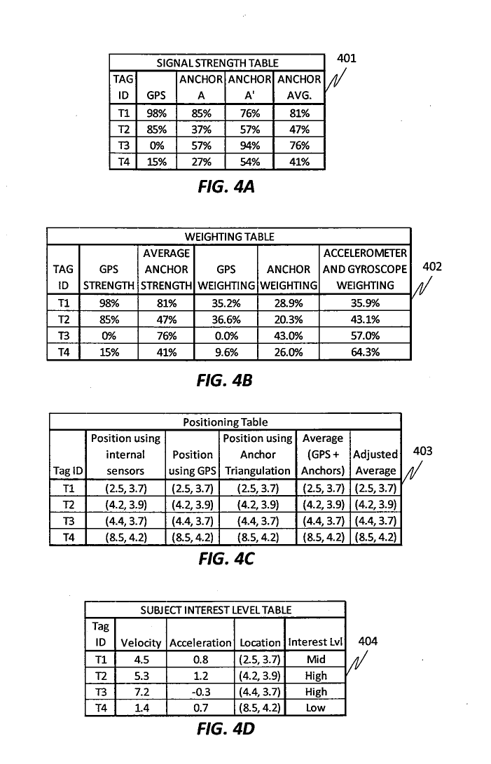

In some embodiments, the computer system 102 may monitor signal strengths of one or more of the position tracking signals for each of the tags. For example, a GPS signal strength for each tag may be transmitted along with the GPS position data by each tag to the computer system 102. Each anchor may, in addition to the position data for each tag, transmit a measurement of the signal strength of the signal for each tag to the computer system 102. By combining and/or averaging the signal strength for each anchor, the computer system 102 may be capable of monitoring the adequacy of the UWB positioning system. Such data may in some embodiments be stored in a table 401 in memory as illustrated in FIG. 4A.

In some embodiments, the computer system may use strength measurements to determine a method of determining a position for each tag. In some embodiments, the computer system may determine the most accurate position estimate method and use the position as determined by that most accurate position for the camera tracking system. In some embodiments, the computer may use the signal strength measurements to determine a weighting for each of the methods and combine the position estimates for each using the weighting. For example, in some situations, a GPS signal for a tag may be of a low strength while the anchor signal for the tag may be higher and thus more reliable. In such a situation the computer system may rely more on the position as provided by the anchors while using the GPS position estimate to a smaller degree. The computer system may store data related to the signal strengths of each tracking method for each tag in a table 402 in memory as shown in FIG. 4B. Such a table 402 may include a weighting percentage based on the signal strength. In some embodiments, the computer system may also rely on accelerometer and/or gyroscope sensor data for each tag to determine the percentage. The position information obtained from data received via the accelerometer and/or gyroscope sensor of each tag may be combined with the GPS and/or anchor position data to achieve an averaged position estimate for each tag.

In some embodiments, the position estimate for each tag for each tracking method may be stored in a table 403 in memory as illustrated in FIG. 4C. The position estimates based on GPS and UWB may be combined into an average (GPS and Anchor) position. The position using the internal sensors (e.g. accelerometer and/or gyroscope sensors) may also be stored in the table 403 and combined with the GPS and/or UWB position estimates into an adjusted average.

In some embodiments, the computer system may determine a subject interest level for one or more tags based on a number of factors. A subject interest level may be used to determine one or more tags to focus on or track using a camera system. In some embodiments, the computer system may determine a velocity and/or acceleration for each tag. Data associated with a tag's velocity, acceleration, and/or location may be used to determine an interest level for each tag. The computer system may store such information in a table 404 in memory as illustrated in FIG. 4D.

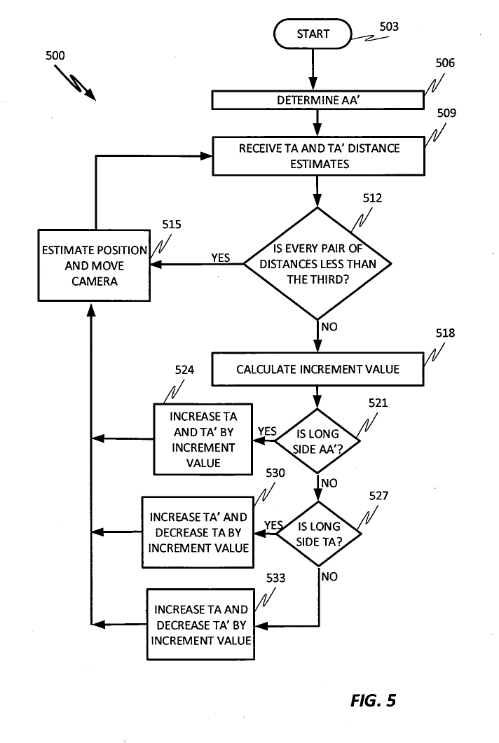

In some embodiments, a method of adjusting triangulation data received from the one or more anchors may be used to estimate the position of each tag. Such a method 500 as illustrated in FIG. 5 may begin 503 by determining a distance between two anchors (“AA′”) 506. The distance AA′ may be automatically measured by the anchors using RF signals or may be entered by a user of the computer system manually using a user interface method. In some embodiments, the distance AA′ may not change during operation of the method 500. The method 500 may involve receiving distance estimates between each anchor and one or more tags (TA and TA′) from each anchor 509. After receiving the distances TA and TA′ from each anchor, the computer system 512 may then determine if an error scenario exists by determining whether each sum of each pair of distances is greater than the third at step 512. For example, if one of the following is true, an error scenario may exist: TA+TA′>AA′; TA+AA′>TA′; or TA′+AA′>TA. If an error scenario exists, i.e. every pair of distances is less than the third, the computer system may use the distance estimates to estimate the position of the tag and move the camera at step 515. After step 515, the computer system may return to step 509 and receive new TA and TA′ distance estimates.

If an error scenario does exist, the computer system may determine which side is the long side. If the long side is AA′ (521) the system may increase both TA and TA′ by an increment value in step 524 and move to step 515. If the long side is TA (527), the system may decrease the TA estimate and increase the TA′ estimate by an increment value in step 530 and move to step 515. If the long side is TA′, the system may decrease the TA′ estimate and increase the TA estimate by an increment value in step 533 and move to step 515. At step 515, the computer system may use the updated estimate distances to estimate a position of the tag and move to step 509 and receive new TA and TA′ distance estimates from the anchors and continue tracking the tags using the method 500.

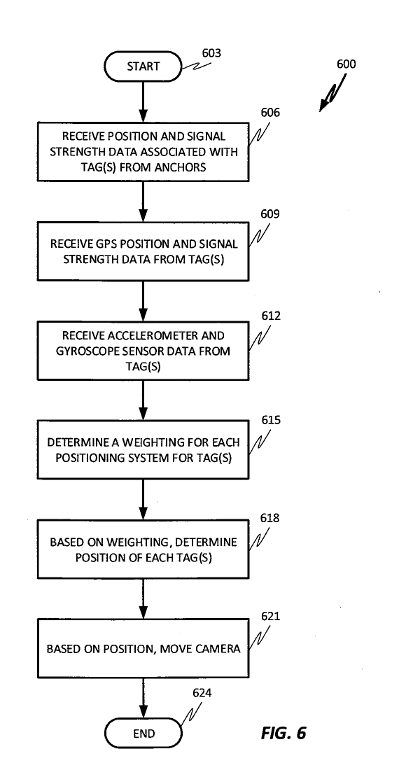

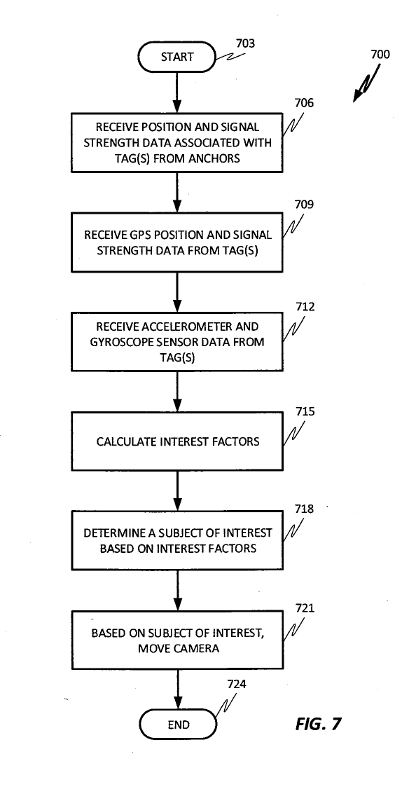

In some embodiments, the computer system may use a method 600 of determining a position of one or more tags and moving a camera based on signal strengths of tracking methods as illustrated in FIG. 6. Such a method 600 may begin 603 by receiving a position and signal strength data associated with one or more tags from anchors 606. The computer system may then receive a GPS position and GPS signal strength data from the one or more tags 609. The computer system may also receive accelerometer and gyroscope sensor data from the one or more tags 612. Based on the received signal strength data, the computer system may determine a weighting for each positioning method for each tag 615. Using the determined weighting, the computer system may then determine a position of the one or more tags 618. Using the determined position, the computer system may then move a camera to capture images of a person associated with the tag 621. At step 624 the method 600 may end.

In some embodiments, the computer system may use a method 700 of determining a subject of interest and moving a camera to capture the subject of interest. Such a method 700 may start at step 703. After beginning the method 700, the system may receive position and signal strength data associated with one or more tags from one or more anchors 706. The system may also receive GPS position and GPS signal strength data from the one or more tags 709. The system in some embodiments may also receive accelerometer and/or gyroscope sensor data from the one or more tags 712. The system, after receiving position data from the one or more sources, may calculate interest factors for each of the one or more tags 715. Interest factors may comprise one or more of a tag velocity, a tag acceleration, a tag position, or other relative data. Interest factors may depend on sport specific rules, such as a position on a playing field, a max player velocity, etc. Based on the interest factors for each tag, the system may then determine a subject of interest 718. For example, in some embodiments, the playing field may be a racetrack and the subject of interest may be the tag in the leading position. Based on the subject of interest, the computer system may move the camera 721 to capture the subject of interest. At step 724, the method 700 may end.

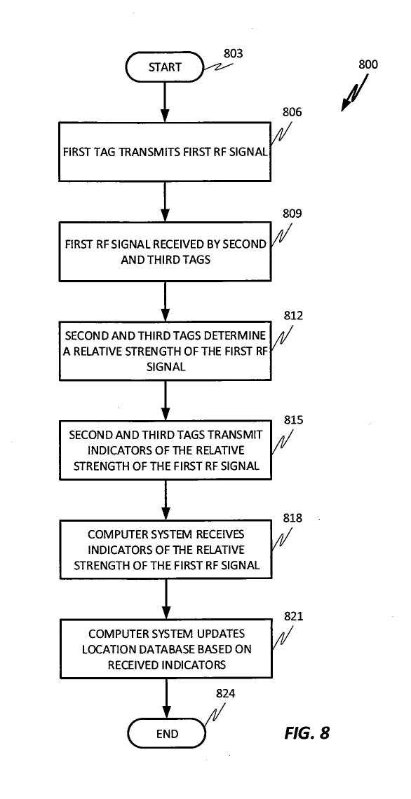

In some embodiments, the computer system may execute a method 800 of determining or updating an estimate of a position of one or more tags based solely, or in part, on data received from other tags. Such a method 800 is illustrated in FIG. 8 and may begin at step 803 at which a computer system environment as illustrated in FIGS. 1 and 2 is in communication with a number of tags as described herein. The computer system may also be in communication with one or more anchors; however, in some embodiments the computer system may be capable of determining or estimating a position of tags in the absence of any communication with any anchors.

At step 806, a first tag of a plurality of tags may transmit one or more RF signals. The signals transmitted by the first tag may be of a specific strength. The signals may comprise data associated with an ID of the tag from which the signals are transmitted. For example, a signal may comprise a data packet. The data packet may include a header or other data field including a tag ID.

The one or more RF signals transmitted by the first tag may be received by one or more tags. For example, in step 809, a first RF signal of the one or more RF signals may be received by a second and a third tag. The tags receiving the RF signals transmitted by the first tag may be capable of determining the source of the signal based on the tag ID contained within the signal.

After receiving the first RF signal, the receiving tags may determine a relative strength of the received signal in step 812. The receiving tags may store a database recording received signal strengths. The signal strength may be stored in memory along with an ID of the tag associated with the signal. The signal strength may be a rating, for example on a 1-100 scale. Alternatively, or additionally, the signal strength may be a percentage or in some other form.

The tags receiving the signal may, in step 815, transmit an indication of the relative strength of the received first RF signal to the computer system. For example, the tags receiving the signal may transmit a data packet comprising a tag ID associated with the tag sending the first RF signal and a signal-strength rating. Data sent from tags to the computer system may additionally comprise information such as an ID of the tag sending the data to the computer system, a timestamp, GPS data, or any other data.

The signal strength data sent from the second and third tags in step 815 may be received by the computer system in step 818. The computer system may store such data in a database in memory. In some embodiments, a signal strength database stored on a tag may be synchronized with a database stored on the computer system. The database stored on the computer system may be updated in real-time or at particular time intervals. The database stored on the computer system may store signal strength data for each of the tags.

At step 821, the computer system may interpret the stored signal strength data for a tag to update a determined or estimated position of the tag relative to other tags based on the strength of the signals sent from that tag as received by other tags. This determination or estimation may be used to update positions of the tags along with other factors, such as GPS data, anchor data, or any other available data. Using the signal strength, the computer system may be capable of estimating a distance between each tag. By obtaining such signal strength data for a particular tag from a number of other tags, the computer system may be capable of triangulating the position of the particular tag. At step 824 the method 800 may end.

The above methods and systems illustrate only some of the embodiments of the computer system upon which the device, or other systems or components described above may be deployed or executed. The computer system is shown comprising hardware elements that may be electrically coupled via a bus. The hardware elements may include one or more central processing units (CPUs); one or more input devices (e.g., a mouse, a keyboard, etc.); and one or more output devices (e.g., a display device, a printer, etc.). The computer system may also include one or more storage devices. By way of example, storage device(s) may be disk drives, optical storage devices, solid-state storage devices such as a random-access memory (“RAM”) and/or a read-only memory (“ROM”), which can be programmable, flash-updateable and/or the like.

The computer system may additionally include a computer-readable storage media reader; a communications system (e.g., a modem, a network card (wireless or wired), an infrared communication device, etc.); and working memory, which may include RAM and ROM devices as described above. The computer system may also include a processing acceleration unit, which can include a DSP, a special-purpose processor, and/or the like.

The computer-readable storage media reader can further be connected to a computer-readable storage medium, together (and, optionally, in combination with storage device(s)) comprehensively representing remote, local, fixed, and/or removable storage devices plus storage media for temporarily and/or more permanently containing computer-readable information. In some embodiments, cloud-based storage solutions may be utilized. The communications system may permit data to be exchanged with a network and/or any other computer described above with respect to the computer environments described herein. Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information.

The computer system may also comprise software elements, shown as being currently located within a working memory, including an operating system and/or other code. It should be appreciated that alternate embodiments of a computer system may have numerous variations from that described above. For example, customized hardware might also be used and/or particular elements might be implemented in hardware, software (including portable software, such as applets), or both. Further, connection to other computing devices such as network input/output devices may be employed.

In some embodiments, the computer system may be capable of operating in both an online mode and/or an offline mode. For example, the system may host its own ad-hoc network. The system may have its own local server and/or database. For example, the system may collect data directly from the anchors, tags, and/or other elements over a wired or wireless network or other communication systems, or such elements may upload data to a wide-area network (“WAN”) to be downloaded by the computer system. In some embodiments, a combination of WAN and other communication means may be used.

Examples of the processors as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIV1926EJ-S™ processors, other industry-equivalent processors, and may perform computational functions using any known or future-developed standard, instruction set, libraries, and/or architecture.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The term “module” as used herein refers to any known or later developed hardware, software, firmware, artificial intelligence, fuzzy logic, or combination of hardware and software that is capable of performing the functionality associated with that element.

What is claimed is:

1. A system, comprising:
a tag associated with a moving object, the tag comprising:
an antenna that transmits signals of a first frequency; and
a Global Positioning System (GPS) that obtains GPS data for the tag;
at least one anchor comprising an antenna that receives the signals transmitted by the tag at the first frequency;
a computer system that receives both the GPS data and information from the at least one anchor indicative of a distance between the tag and the at least one anchor and determines whether to track a position of the tag via: (1) the GPS data; (2) the information from the at least one anchor indicative of the distance between the tag and the at least one anchor; or (3) a combination of the GPS data and the information from the at least one anchor indicative of the distance between the tag and the at least one anchor; and
a camera system, comprising:
a communication system that receives information about the position of the tag from the computer system; and
a camera control system that controls a position of a camera based on the received information about the position of the tag from the computer system.

2. The system of claim 1, wherein the computer system arbitrates between using the GPS data and/or the information from the at least one anchor indicative of the distance between the tag and the at least one anchor based on an estimated error in the GPS data and/or an estimated error of the distance between the tag and the at least one anchor.

3. The system of claim 1, wherein the computer system arbitrates between using the GPS data and/or the information from the at least one anchor indicative of the distance between the tag and the at least one anchor based on a strength of signals received at the at least one anchor from the tag.

4. The system of claim 1, wherein the computer system arbitrates between using the GPS data and/or the information from the at least one anchor indicative of the distance between the tag and the at least one anchor based on whether or not the tag is located indoors or outdoors.

5. The system of claim 4, wherein the computer system receives a user input indicating whether or not the tag is located indoors or outdoors.

6. The system of claim 1, wherein the first frequency is between 3.1 and 10.6 GHz.

7. The system of claim 1, wherein the at least one anchor is collocated with the camera system.

8. The system of claim 1, wherein the computer system tracks the position of the tag via the combination of the GPS data and the information from the at least one anchor indicative of the distance between the tag and the at least one anchor.

9. The system of claim 8, wherein the computer system weights the GPS data and the information from the at least one anchor indicative of the distance between the tag and the at least one anchor based on an estimated error in the GPS data and/or an estimated error in the distance.

10. The system of claim 8, wherein the computer system weights the GPS data and the information from the at least one anchor indicative of the distance between the tag based on signal strength of the signals received at the at least one anchor.

11. The system of claim 1, wherein the at least one anchor comprises a second tag performing as an unfixed anchor.

12. A method, comprising:
receiving, by a processor, signals of a first frequency from at least one anchor, wherein the signals are transmitted to at least one anchor by an antenna associated with a tag, wherein the tag is associated with a moving object; and
obtaining, by the processor, Global Positioning System (GPS) data for the tag;
receiving, by the processor, information from the at least one anchor, wherein the information from the at least one anchor is indicative of a distance between the tag and the at least one anchor;
determining, by the processor, whether to track a position of the tag via one or more of the GPS data and the information from the at least one anchor; and
transmitting, by the processor, information about the position of the tag to a communication system of a camera system, wherein the camera system comprises a camera control system, wherein the camera control system is configured to control a position of a camera based on the received information about the position of the tag from the processor.

13. The method of claim 12, further comprising arbitrating, by the processor, between using the GPS data and/or the information from the at least one anchor indicative of the distance between the tag and the at least one anchor based on an estimated error in the GPS data and/or an estimated error of the distance between the tag and the at least one anchor.

14. The method of claim 12, further comprising arbitrating, by the processor, between using the GPS data and/or the information from the at least one anchor indicative of the distance between the tag and the at least one anchor based on a strength of signals received at the at least one anchor from the tag.

15. The method of claim 12, further comprising arbitrating, by the processor, between using the GPS data and/or the information from the at least one anchor indicative of the distance between the tag and the at least one anchor based on whether or not the tag is located indoors or outdoors.

16. The method of claim 15, further comprising receiving, by the processor, a user input indicating whether or not the tag is located indoors or outdoors.

17. The method of claim 16, wherein the first frequency is between 3.1 and 10.6 GHz.

18. The method of claim 12, wherein the at least one anchor is collocated with the camera system.

19. The method of claim 12, further comprising tracking, by the processor, the position of the tag via the combination of the GPS data and the information from the at least one anchor indicative of the distance between the tag and the at least one anchor.

20. A computer program product, comprising:
a non-transitory computer-readable storage medium having computer-readable program code embodied therewith, the computer-readable program code configured when executed by a processor to:
receive signals of a first frequency from at least one anchor, wherein the signals are transmitted to at least one anchor by an antenna associated with a tag, wherein the tag is associated with a moving object; and
obtain Global Positioning System (GPS) data for the tag;
receive information from the at least one anchor, wherein the information from the at least one anchor is indicative of a distance between the tag and the at least one anchor;
determine whether to track a position of the tag via one or more of the GPS data and the information from the at least one anchor; and
transmit information about the position of the tag to a communication system of a camera system, wherein the camera system comprises a camera control system, wherein the camera control system is configured to control a position of a camera based on the received information about the position of the tag from the processor.
